(19) United States
(12) Patent Application Publication
(10) Pub. No.: US 2007/0110909 A1
(43) Pub. Date: May 17, 2007

(54) Reduction or elimination of microbial growth and biofouling of salted wet biomass byproducts

(76) Inventors: Louis A. Isakoff, Virginia Beach, VA (US); Guerry L. Grune, Virginia Beach, VA (US)

Correspondence Address: GUERRY LEONARD GRUNE, 784 S VILLIER CT., VIRGINIA BEACH, VA, 23452, US

(21) Appl. No.: 11/247,873

(22) Filed: Nov. 14, 2005

(51) Int. Cl. B05D 1/02; B05D 1/28; C09K 3/18; C09D 5/14

(52) U.S. Cl. 427/421.1; 252/70; 106/13; 106/15.05; 427/428.01

(57) ABSTRACT

The invention describes a method, composition, and system of treating soluble organic compounds in combination with salts or brine used primarily for freezing point depression liquids, capable of aerobic and anaerobic microorganism growth such that by applying sufficient caustic in a caustic wash to an inside surface of any liquid media transport device for these freezing point depression liquids a caustic residue or caustic concentration associated with the caustic wash is created that results in mitigating or eliminating microorganism growth.

### FIELD OF THE INVENTION

The present invention is directed to an environmentally acceptable and negligibly corrosive deicing composition comprising by-products from, for example, a wet milling process of corn or other crops, the by-products of which are free from the use of biocide to prevent microbial growth during storage or use. Specifically, the invention includes the use of preferably a clear condensate from any biomass by-product, preferably crop or animal based biomass by-products that are free of any biocide normally required to inhibit microbial growth. The invention includes the use of these by-products from biomass so that they may be used as deicing compositions in a manner that helps to reduce the buildup of snow and ice on roads, bridges, runways, taxiways and other outdoor surfaces.

### BACKGROUND OF THE INVENTION

It is well known that the ice and snow located on roads and bridges significantly slow traffic and pose increased danger to the general public. Mechanical snow removal is often used to alleviate some of the traffic problems. It is also known that chemical compounds, such as chloride salts, whether in solid form or in solution or in admixture with sand and other substances, are often used to treat the roadways to melt snow and ice. Most deicing compounds, however, are environmentally harmful, and therefore, municipalities are often restricted in the amounts and types of substances that they may use to help control the buildup of snow and ice.

Most chemicals used to treat ice and snow on outside surfaces are detrimental for the following reasons; they damage the soil and surrounding vegetation because the salts turn the soil alkaline and are also absorbed into the root systems of the plants. The chemicals also damage freshwater streams, rivers and lakes and are often absorbed into underground water systems. The process is known as salt water intrusion.

In addition, the salts cause significant damage to vehicles, as well as concrete and metallic structures that are near roadways because of the corrosive effects of these salts. It is well known that many salts cause spalling in concrete structures, which significantly reduce the strength and life of such structures. For the foregoing reasons, many states have banned the use of salts, while others have placed significant restrictions on the usage of salts. The corrosive nature of salts and saline solutions is also of prime importance when considering alternative compositions and methods for deicing.

It is well known that the use of salts will control most forms of bacterial activity in organic compounds such as food. Therefore mixing steepwater or other biomass by-products with salts is a form of bacterial growth control. As mentioned in the previous paragraph, though, is that in some applications the use of salts is not desirable. Also, in certain specific cases, the use of salts are not sufficient to limit or eliminate bacterial growth and often the use of a biocide or other suitable inhibitors are required. The use of these biocides are undesirable for at least two reasons; cost and environmental concerns. In road de-icing applications, the spread of a biocide may be environmentally unacceptable as it could damage wildlife and/or plant life in the vicinity of the application. As most road de-icing solutions are based primarily on undesirable or otherwise not useful by-products that are inexpensive, the need for a biocide and therefore an additional cost associated with that need is also undesirable.

Thus, readily available carbon sources which are present in the corn steep are: sugars and organic acids, as sources of nitrogen and carbon: amino acids and polypeptides and, as sources of trace elements which are necessary for the growth of microorganisms “buffering” agents and minerals. Determining the source and the type of microorganisms has been a relatively recent subject of investigation. The results are presented here to illustrate the necessity of using a proper biocide or other treatment that will mitigate or eliminate the growth of the various forms of bacteria and/or microbial organisms that may use steepwater and other wet biomass byproducts as a host and source of nutritional sustenance.

Wet corn milling generates large volumes of corn steep water, which is composed of kernel extractives, microbes (principally lactobacilli), numerous products of fermentation processes, and dissolved SO₂. In order to understand better the process of steeping and the potential uses of corn steep water, its composition was analyzed and compared at various times during the steeping from four different industrial processes. Of particular interest were the analyses of corn steep water for carbohydrates, amino acids, polypeptides, fatty acids and other organic compounds, hydrolytic enzymes, heavy metals and inorganic ions. This study, together with an earlier analysis of corn steep water for myo-inositol phosphates (Hull and Montgomery, 1995), provides a basis for informed judgment of the nutritional and biotechnological value of corn steep water, an abundant byproduct of the corn wet-milling industry.

The complete process for wet corn milling where different fractions, including a clear condensate, may be produced, is the focus of the present invention.

In a study by Peters and Cox, (Corn-associated. Steep Lactobacilli in Laboratory Steeping Peters, E. M., and C. D. Cox. Appl. Environ. Microbiol. 1997), bacteriological and biochemical surveys of industrial steep tanks revealed inconsistencies between the extremely low bacterial numbers sometimes found in a series of tanks, and the increasing levels of lactic acid in the same tanks. A similar inconsistency was observed during laboratory steeping where lactic acid increased as bacterial numbers decreased following the inoculation of steep tanks. The glass walls of the laboratory steep tanks revealed the formation of large, flocculent masses during steeping. Vigorous mixing dissociated the masses and the total, mixed counts of bacteria were more consistent with the steady rates of lactic acid production. Scanning electron microscopy revealed that bacteria formed the masses that veiled the corn kernels and that bacteria were also firmly attached to the surfaces (pericarp) of the kernels. Ninety percent of the steep lactobacilli were near to or associated with the corn kernels in ecosystems that help to explain the apparent inconsistencies between bacterial numbers and lactic acid production during steeping.

Identification of the bacterial strains was first explored by the same investigators in a paper entitled “Identification of Different Strains of Steep Lactobacillus from Industrial Steep Tanks” Peters, E. M., and C. D. Cox. Appl. Environ. Microbiol. 1997. It was found that homolactic lactobacilli constituted a considerable proportion of the bacterial population in industrial steep water samples collected from 7 different mid-western corn wet milling plants. Twenty-nine homolactic and five obligate heterolactic lactobacillus isolates were compared with Lactobacillus rhamnosus ATCC 15820, a strain isolated by Kuznetsov in 1959 from Russian steep water. Chromosomal DNA analysis using pulsed-filed gel electrophoresis allowed the division of the 29 homolactic isolates into 10 different strains using the NotI restriction enzyme and into 15 different strains using the SmaI enzyme. Most of the recent homolactic isolates were capable of luxurious growth at 52° C., fermented a select group of carbohydrates found in corn kernels, and were resistant to bisulfite concentrations reaching 0.1% at pH 4.5. A different set of lactobacillus isolates fermented a broader range of carbohydrates by obligate heterolactic and factultative heterolactic fermentation reactions. Strain ATCC 15820 had an even wider range of carbohydrates that were fermented, was very sensitive to bisulfite, and could not grow at 52° C. Strain ATCC 15820 and the heterolactic lactobacilli were extensively cut by both restriction enzymes and could not be typed by the same system.

More generally, microbial contamination of polymer emulsions can lead to a range of effects, including color changes, odors, viscosity changes, pH changes, and visible surface growth. It is known in the art that polymer emulsions are susceptible to contamination by a broad range of biodeteriogenic microbes. Examples of microorganisms found to contaminate polymer emulsions include, Aeromonas hydrophilia, Alcaligenes faecalis, Corynebacterium ammoniagenes, Enterobacter aerogenes, Escherichia coli, Klebsiella pneumoniae, Pseudomonas aeruginosa, Proteus vulgaris, Providencia rettgeri, Pseudomonas stutzeri, Shewanella putrefaciens, Serratia liquefaciens, Acinetobacter baumannii, Burkholderia cepacia, Chryseobacterium meningosepticum, Sphingobacterium spiritivorum, Ralstonia pickettii, GABL, Geotrichum candidum, Aspergillus species, Sporothrix species, Trichoderma viride, Cladosporium species, Rhodoturula glutinis, Candida guillermondi, Penicillium species, and Candida tropicalis.

Therefore, as discovered by Peters and Cox and others, the difference in bacteria and microorganisms within steepwater or other polymeric based biomass, constitutes a need to reduce or eliminate more than one strain and even though it is customary to treat soluble organic compositions with one or more biocides to control the population of microorganisms in the solution to prevent biofouling, often the biocide(s) used are either inappropriate or insufficient to prevent the fouling.

This biofouling can occur anytime after initial processing, but usually occurs during storage under non-ideal conditions. Several factors play a role in the process of biofouling including; water quality, pH, temperature, salinity and aerobic/anaerobic conditions. As detailed above, the particular types of microorganisms and the extent of microbial growth depend on the composition of the solution and many other, often uncontrollable factors.

A wide variety of materials have been used to control microbial activity in different environments for steepwater and other wet biomass by-products, some of which include; chlorinated/brominated compounds, glutaraldehyde, isothiazolones, organotin formulations, copper salts, quaternary ammonium compounds (SD Strauss and PR Puckorius in J. Power, S1, June 1984), and triazines. Each has deficiencies related to toxicity, pH and temperature sensitivity, limited effectiveness, chemical stability, and/or compatibility. Oxyfluorfen in combination with diuron (3-(3,4-dichlorophenyl)-1,1-dimethylurea) has been found to be an effective herbicide for weed control in sugarcane fields (H J Yeh, Taiwan Sugar, 27(4), 125-129, 1980), nectarine crops (M J Hartley, Proc. N. Z. Weed Pest Control Conf., 40th, 140-143, 1987), and biomass production (P Felker and C. E. Russell, J. Hortic. Sci., 63(1), 149-155, 1988). Each of the biocides mentioned are also costly and certainly each pose a potential threat to the environment.

For farm feed products, Table 1 below indicates permitted substances that have anti-microbial activity and uses of these substances for different applications. Preservatives in this case, are primarily anti-bacterial agents that either retard or eliminate oxidation as well as retard or eliminate growth of microorganisms.

TABLE 1
Known Permitted Preservatives for Animal Feed Products

| | | | MAXIMUM CONTENT | MINIMUM CONTENT |
|---|---|---|---|---|
| | | | (mg/kg IN | (mg/kg IN |
| | CHEMICAL | | COMPLETE FEED | COMPLETE FEED |
| NAME OR DESCRIPTION | FORMULA | KIND OF ANIMAL | INGREDIENTS) | INGREDIENTS) |
| Acetic acid | C₂H₄O₂ | | | |
| Ammonium formate | C₃H₉O₂N | | | |
| Calcium acetate | C₄H₆O₄Ca | | | |
| Calcium citrates | — | | | |
| Calcium formate | C₂H₂O₄Ca | | | |
| Calcium lactate | C₆H₁₀O₆Ca | | | |
| Calcium propionate | C₆H₁₀O₄Ca | | | |
| Calcium sorbate | C₁₂H₁₄O₄Ca | | | |
| Citric acid | C₆H₈O₇ | | | |
| Disodium bisulphite (Sodium | Na₂S₂O₅ | Dogs and cats | 500 alone or | |
| metabisulphite) - Not permitted | | | together as SO2 | |
| in unprocessed meat and fish | | | | |
| DL-Malic acid | C₄H₆O₅ | | | |
| Ethyl 4-hydroxybenzoate | C₉H₁₀O₃ | Pet animals | No limit | |
| | | All species | No limit | |
| | | of animals | (for silage only) | |
| Formaldehyde | CH₂O | Pigs up to the | 600 (skimmed | |
| | | age of six months | milk only) | |

Further definitions regarding “anti-microbial” agents are given below so that the nature of the present invention can be more fully appreciated.

Preservatives are widely used to extend the shelf-life of food but while they stop food from going mouldy or rancid, some have side effects and questions exist surrounding their safety. These include:

Sulphites; Sulphur Dioxide; Sodium Sulphite; Sodium Bisulphate; Sodium Metabisulphite Potassium Sulphite; Potassium Sulphite; Calcium Sulphite; Calcium Hydrogen Sulphite Potassium Bisulphite.

Sulphur dioxide and eight sulphite compounds are used as preservatives in a wide range of foods including dried fruit and vegetables, fruit juices, soups, processed fish, cooked sausages, some brands of biscuits, fruit bars, tomato paste, some jams, instant coffee, gelatine, sauces, gravy and wine and beer.

Because sulfites prevent fruit and vegetables from going brown, they may also be sprayed onto French fries in fast food outlets, and are used as bleaching agents for flour and food starches. They prevent yeast and bacterial growth in food and stop fats and oils from going rancid. Some sulphites are used to sterilize equipment for the food manufacturing industry.

Sulphites have been linked to severe asthma attacks in an estimated 5-10 percent of asthma sufferers and are also linked to stomach problems and symptoms such as blurred vision, dizziness, irregular breathing and nervous irritability in some people.

Scientists have found treating food with sulphites can reduce its vitamin B1 or thiamine content which is vital to the nervous system. Foods containing more than 10 ppm of sulphur dioxide should be labeled to help sensitive people avoid them.

Nitrates and Nitrites; Potassium Nitrite; Sodium Nitrite; Sodium Nitrate; Potassium Nitrate

Nitrites and nitrates are used to prevent highly toxic bacteria that cause botulism food poisoning from developing in red meat and fish. They also perform a cosmetic function by turning processed meat pink.

They are found in virtually all cooked and cured meat, sausages, bacon, ham, frankfurters, hot dogs, salami, corned beef, pate and luncheon sausage, and may also be used in fresh meat and chicken that has been prepared in some way for sale.

Nitrates can convert into nitrites in the body. When nitrites combine with other chemicals known as amines in the gastric juices of the stomach, they form compound known as nitrosamines, which have been linked to the development of cancers in many species of animals.

JECFA (the joint FAO/WHO Expert Committee on Food Additives) has stated that it is “highly probable” that nitrites are carcinogenic in humans. Nitrites are heavily restricted in some European countries.

Benzoates; Benzoic Acid; Sodium Benzoate; Potassium Benzoate; Calcium Benzoate; Propylparaben or Propyl-p-Hydroxy-Benzoate; Methylparaben or Methyl-p-Hydroxy-Benzoate.

Benzoates are tasteless, odorless preservatives used in some fruit juices, cordial, soft drinks, sauces and toppings, margarine, jam, pickles, chutney, cider, coconut milk, non-canned, preserved fish, milk-shake syrups and concentrated tomato juice.

Benzoates have been linked to allergies, asthma, skin reactions, hyperactivity, gastric irritation, and migraines. When used in combination with sodium bisulphate, the reactions for asthmatics may be even more severe.

Benzoate can affect the natural balance of bacteria in the intestines. Tests have found benzoates produce toxic effects in many species and the former Soviet Union, heavily restricted their use.

Regulatory bodies such as JECFA (the joint FAO/WHO Expert Committee on Food Additives) acknowledge that benzoic acid can provoke allergy and intolerance in some people, especially those who suffer from asthma, hyperactivity and urticaria.

Antioxidants: Antioxidants stop oils and fats from going rancid. They also stop food going brown or developing black spots, and they prevent artificial flavorings and colorings from decomposing. At least 20 different antioxidants are permitted for use in food, including:
Butylated hydroxyanisole (BHA)
Butylated hydroxytoluene (BHT)

BHA and BHT are used in hundreds of processed foods and it is easy to consume more than the recommended daily amount. Synthetically manufactured, petroleum-based and fat-soluble, these antioxidants are found in chips, fried snack foods and baked foods such as biscuits. They are also found in some vegetable oils, shortening, lard, fat, margarine, carbonated drinks, cheese spreads, chewing gum, ice cream, dry breakfast cereal, cosmetics, animal feeds and drugs. BHA and BHT have been linked to hyperactivity and other allergic reactions such as rashes and asthma as well as other ill-health effects in humans. They accumulate in body fat.

In animal tests, BHT has caused liver cancer and lung tumors, increased blood cholesterol, reduced growth rates and body weight and been linked to birth defects in rats.

A Japanese study found BHA caused cancerous tumors in the fore-stomachs of rats, mice and hamsters leading to the Japanese Government banning it from food.

Some European countries heavily restrict use of BHA and BHT, but in New Zealand it can be used up to 100 ppm in food.

Cationic compounds, such as quaternary ammonium compounds, are well known in the antimicrobial art and are widely used as disinfectants for surfaces. For example, they are used to disinfect floors, walls, countertops, equipment surfaces, food contact surfaces, and the like in hospitals, schools, nursing homes, restaurants, and residential homes.

Furthermore, combinations of detergents with cationic compounds are widely used formulations for cleaning and disinfecting or sanitizing such surfaces with a single product. Cationic compounds are also used to inhibit the growth of algae and microorganisms in water, such as in swimming pools. Cationic compounds have been utilized on a limited basis for the preservation of industrial products and to prevent microbial growth in aqueous systems.

U.S. Pat. No. 3,970,755 (Gazzard et al., 1976) discloses biocidal compositions for aqueous systems comprising lauryl benzyl dimethyl ammonium chloride or cetyl trimethyl ammonium chloride, and 1,2-benzoisothiazolin-3-ones.

U.S. Pat. No. 4,661,503 (Martin et al., 1987) discloses a synergistic biocide composition of n-dodecylguanidine hydrochloride (DGH) and a mixture of 5-chloro-2-methyl-4-isothiazolin-3-one and 2-methyl-4-isothiazolin-3-one for treating industrial process waters to prevent the growth of gram negative bacteria and fungi.

U.S. Pat. No. 4,725,623 (Whitekettle et al., 1988) discloses a bactericidal composition for aqueous systems comprising a synergistic aqueous mixture of 2-bromo-2-nitropropane-1,3-diol and n-dodecylguanidine.

U.S. Pat. No. 4,906,385 (Lyons, et al., 1990) discloses the use of water soluble C8-C18 alkyl guanidine salts, especially n-dodecylguanidine hydrochloride, for controlling macroinvertebrate biofouling of industrial cooling water system.

U.S. Pat. No. 5,041,463 (Whitekettle et al., 1991) discloses a bactericidal composition for aqueous systems, such as pulp and paper mill systems, comprising a combination of glutaraldehyde and dodecylguanidine hydrochloride.

U.S. Pat. No. 5,457,083 (Muia et al., 1995) discloses synergistic antimicrobial compositions containing polyether polyamino methylene phosphonates (PAPEMP) and one or more non-oxidizing biocide, such as didecyl dimethyl ammonium chloride, dodecylguanidine hydrochloride, methylene bisthiocyanate, and 5-chloro-2-methyl4-isothiazolin-3-one. The combination is reported to be useful in aqueous systems in a variety of industrial applications, such as papermaking, paints, adhesives, latex emulsions, and joint cements. Examples show that addition of PAPEMP to a non-oxidizing biocide improves bacterial kills in an aqueous system over 24 hour period.

El-Zayat and Omran, “Disinfectants Effect on the growth and Metabolism of Acetobacter aceti” (Egypt J-Food-Sci., 11(1-2), 1983, pages 123-128) evaluate quaternary ammonium compounds, such as cetyl trimethylammonium bromide, as disinfectants against the growth and metabolism of Acetobacter aceti. Handbook of Biocide and Preservative Use, Edited by H. W. Rossmore, Blackie Academic & Professional, 1995, pages 361-362, describes biocidal surfactants for preservation of cosmetics and toiletries. Quaternary amines are reported to be potent antimicrobial substances.

One well known method for preventing biodeteriogenic microbe contamination involves missing an effective amount of the cationic compound with the solution to be preserved. Examples of specific cationic compounds that are particularly effective have been stabilized with protective colloids, such as poly (vinyl alcohol), against biodeteriogenic microbes are: substituted pyridinium salts, substituted guanidine salts, tetrasubstituted ammonium salts, and polymeric cationic compounds, in which the substitution can be an alkyl, a cycloalkyl, and/or an aryl group of 2 to 18 carbons. The cationic compounds are also particularly effective in preserving polymer emulsions with low VOC's (i.e. less than 1000 ppm VOC).

These cationic compounds are effective as stand-alone preservatives, exhibiting a broad spectrum of microbicidal activity against bacteria and fungi for an extended period of time, or can also be used in combination with other biocides, such as isothiazolinone derivatives.

The cationic compounds are particularly effective in polymer emulsions containing little or no anionic comonomers, anionic surfactants, or other anionic constituents. The preservative efficacy and potency of the cationic compounds can be diminished in the presence of high surface area polymer particles and/or free aqueous phase nonionic surfactant.

Potassium sorbate (also known as 2,4-hexadienoic acid), is one such cationic compound, is a naturally occurring unsaturated fatty acid, and is completely safe with regard to health issues. It is often used as a mold inhibitor. In the case of steepwater, this compound may also be effective in reducing microbial activity, however when mixing with many calcium, potassium, and other salts, flocculation and/or precipitation has occurred (presumably primarily due to high phosphate content)—a highly undesirable characteristic. The possibility of using potassium sorbate as a useful biocide or as a washing agent for holding tanks with steepwater, has not been fully explored, however the cost of this compound is increasing due to its use in both animal and human feed products.

What has not been addressed is how to prohibit aerobic or anaerobic microbial activity without the use of additive salts, toxins or biocides, thereby preserving the natural and biodegradable characteristics of steepwater and other associated biomass by-products. Based on the aforementioned performance deficiencies of conventional compounds, there is a need for a more effective method that can be used, that is cost effective for the end user, reducing or eliminating biofouling of soluble organic compositions, and eases the pollution load on environmental systems. Reduction or elimination of undesirable side effects to nearby non-target organisms, such as fish, useful crops, etc., is also a goal of the present invention.

Finally, it may also be advantageous to combine a clear, translucent, or opaque steepwater or other liquid based biomass condensate or other by-product for anti-icing compositions with a coloring agent. This agent should be preferably water soluble, inexpensive and also environmentally benign.

Colors: Colors are used to give the appearance of freshness, to make solutions look more natural, to replace color lost during processing, and to make solutions more appealing.

The U.S. government allows nearly 50 colors in our food, including 10 controversial synthetic dyes banned overseas because of concerns about their safety (in food consumption).

There are basically two types of food dyes: natural or nature-identical dyes, and synthetic dyes that are mostly coal-tar derivatives. These are formed from chemical compounds produced when coal is distilled, and are used in textiles, inks, paints, cosmetics, pharmaceuticals and pesticides as well as foods.

In New Zealand, it has been recommended to avoid the following dyes, which are linked to a wide range of allergic reactions including asthma, hyperactivity and skin rashes. Some colorants have been linked to carcinogenic tumors in laboratory animals: Tartrazine; Sunset Yellow; Carmoisine or Azorubine; Amaranth; Ponceau 4R; Erythrosine; Allura Red; Brilliant Blue; Green S; Caramel; Brilliant Black; Brown HT; Aluminium

### FURTHER DESCRIPTION OF THE PRIOR ART

U.S. Pat. No. 5,635,101 to Janke, et. al. describes an environmentally acceptable and negligibly corrosive deicing composition comprising steepwater, a by-product from a wet milling process of corn, the by-products of which are biodegradable. The invention also relates to the use of a deicing composition in a manner that helps to reduce the buildup of snow and ice on roads, bridges, runways, taxiways and other outdoor surfaces.

U.S. Pat. No. 5,965,058 to Janke, et. al., describes a deicing composition comprising steepwater solubles, said steepwater solubles being derived from steeping a grain such as corn, soybean, wheat, barley or sorghum. Janke teaches no other than adding salts to steepwater for treatment and does not address the issues of shipping or treating steepwater to prohibit bacterial growth.

U.S. Pat. No. 4,980,282 to de Troostembergh, et. al., and assigned to CPC International, describes a process for the treatment of corn steep water, characterized by separating the water from the corn and initially adjusting the pH of the water to 3.5 to 5.5 and maintaining the water in contact with process biomass for a period in excess of four hours at a temperature of 40 to 48° C. Additionally the corn steepwater is processed and characterized in that the pH is greater than 5.7, and that the pH is adjusted by the addition of ammonia. This invention involves the use of ammonia as a biocide to balance the pH of the steepwater.

U.S. Pat. No. 4,172,783 to Adams, et. al., and assigned to The Permutit Co., describes a condensation purification process wherein the improvement comprises the sequential steps of passing an aqueous solution of a water soluble calcium salt through a strong base anion exchange resin of substantially uniform basicity to provide an aqueous solution of calcium ions substantially free of anions other than hydroxyl, contacting the aforesaid first layer with said solution of calcium ions substantially free of anions other than hydroxyl to displace the sodium ions on said entrained cation exchange particles with calcium. Adams teaches the use of salts to create an anionic condensate.

U.S. Pat. No. 5,824,222 to Keyser, et. al., and assigned to Micronair LLC, describes a method of treating waste by continuously recirculating the settled biologically treated waste from the second vessel to the first vessel, and removing during recirculation suspended inert solids without significant removal of biological solids larger in size than at least some of the inert removed solids.

WIPO Publication WO05047403A1 to Sakrowski, Klaus, and assigned to Unternehmen Fur Spezialffasern. Sakrowski describes textiles of mineral (especially basalt) fibers or filaments and E-glass fibers that can be used as biocide-free protective coverings for underwater structures.

U.S. Pat. No. 3,721,622 to Finn, et. al., describes a process for the biooxidation of nitrogen-deficient aqueous organic waste comprising adding aerobic bacteria to the waste in order to create an effluent at a pH of from about 6 to about 9.

U.S. Pat. No. 5,288,407 to Bodwell, et. al., and assigned to Henderson & Bodwell, describes a process for the microbiological nitrification and the microbiological denitrification of wastewater consisting of; settling, nitrification by aerobic microbiological activity, recycling the treated wastewater, denitrification with a microbiological media and disposing of the wastewater. This invention involves the use of microorganisms for the treatment of wastewater.

European publication No. EP0986517A1 to Harvey, et. al., and assigned to Iosolutions Inc., describes a method and apparatus for producing bacteria-free iodine-species-containing drinking water for farm animals. A continuous flow of iodine species-containing water is fed to a farm animal drinking water distribution network with reduced risk of back-contamination by bacteria-containing water through the network.

WIPO Publication WO0129146A1 to Westmark, et. al., and assigned to Foster-Miller Inc., describes a deicing composition, wherein the composition comprises at least two freezing point depressants (FPD) that are nontoxic, biodegradable and have different rates of degradation, and at least one surfactant, wherein the surfactant is non-ionic, non-toxic and also biodegradable.

U.S. Pat. No. 5,662,940, to Hight, et. al., and assigned to the University of Houston, relates to biocidal methods and compositions for recirculating the water system, comprising a hypochlorite donor and a bromide donor. This patent specifically relates to the disinfection of water in cooling towers, swimming pools and spas.

U.S. Pat. No. 5,424,032 to Christiansen, et. al., and assigned to Diversey Corporation, describes a method of treating water using innocuous chemicals for the treatment of microorganisms. The oxidizing biocide including free halogens, or hypohalites, or salts of hypohalites or hypohalite ion OX wherein X is Cl or Br, and halohydantoins such as bromochloro- or dibromodimethyl hydantoins or any oxidants which are used for disinfecting water.

U.S. Pat. No. 4,385,973 to Reis, et. al., and assigned to August K. Reis, relates to a process for disinfecting swimming pool water which comprises circulation with a pump by anodic oxidation in a reactor.

European patent application EP 384661A to Lange, et. al. and assigned to Rohm & Haas Co., discloses the use of diphenylethers for use as antialgal compositions.

U.S. Pat. No. 4,975,111 to Woodruff, et. al., and assigned to Rohm & Haas Co., discloses the use of said diphenylethers with isothiazolones for use as antialgal compositions.

European patent application EP 143547A to Coltharp, et. al., and assigned to Chevron Reasearch Corp., teaches the use of oxyfluorfen diphenylether/glyphosate (N-(phosphonomethyl)glycine) mixtures as having enhanced herbicidal activity towards weeds and grasses.

### SUMMARY OF THE INVENTION

The present invention is directed to a method and associated system for providing a primarily environmentally acceptable anti-freeze and deicing composition, the active ingredient of which is a by-product of a wet biomass, preferably a wet biomass condensate and more preferably a by-product of the wet milling process of corn, known in the industry as steepwater and even more preferably a clear condensate of steepwater. The composition is water soluble, negligibly corrosive, inexpensive, and widely available in large quantities. The present invention is also directed to a method of preserving the wet biomass compositions against biodeteriogenic microbe attack and spoilage or biofouling using a specific washing technique for the holding vessel (railcar, tanker, etc.).

The present invention is also directed to the use of said deicing composition to help keep sidewalks, driveways, patios, porches, rooflines and other outdoor surfaces free of ice and snow without the addition of salts or other corrosive additives.

Generally, substances that are to be used as deicers must have the following characteristics: suitable water solubility; a low freezing temperature in solution; availability on an industrial scale at a low cost; non-corrosiveness; environmentally acceptable; and capable of being applied by generally known and available means and above all, cost effective in comparison with commonly used road salts such as MgCl, NaCl, CaCl₂, combination brines, and the like.

Preferably, the present invention relates directly to prohibiting aerobic and anaerobic microbial growth of steepwater and other similarly prepared wet biomass byproducts by preparatory caustic washing of the inside of railroad tank cars and tank trucks prior to filling the tanks with steepwater. This is normally accomplished, in the case of steepwater, by raising the pH to at least 8.5 or beyond, although an acceptable range of 8-10 is likely acceptable.

Additionally, in the case of microbially inhibited steepwater, it may then be removed from the tanks as a liquid and packaged in individual containers, such as gallon bottles for commercial use without the requirement of additional treatment. Individuals could then use the biocide free steepwater with or without salt as a natural deicer, with the additional benefit of adding natural organic nutrients to ornamental plants, which normally adorn private residences near sidewalks, driveways and under roof eaves.

In view of the foregoing, it is a primary object of the present invention to provide an environmentally friendly, negligibly corrosive anti-freeze and deicing composition suitable for making surfaces free of snow and ice, which is biocide free and economic/

### DETAILED DESCRIPTION OF THE INVETION

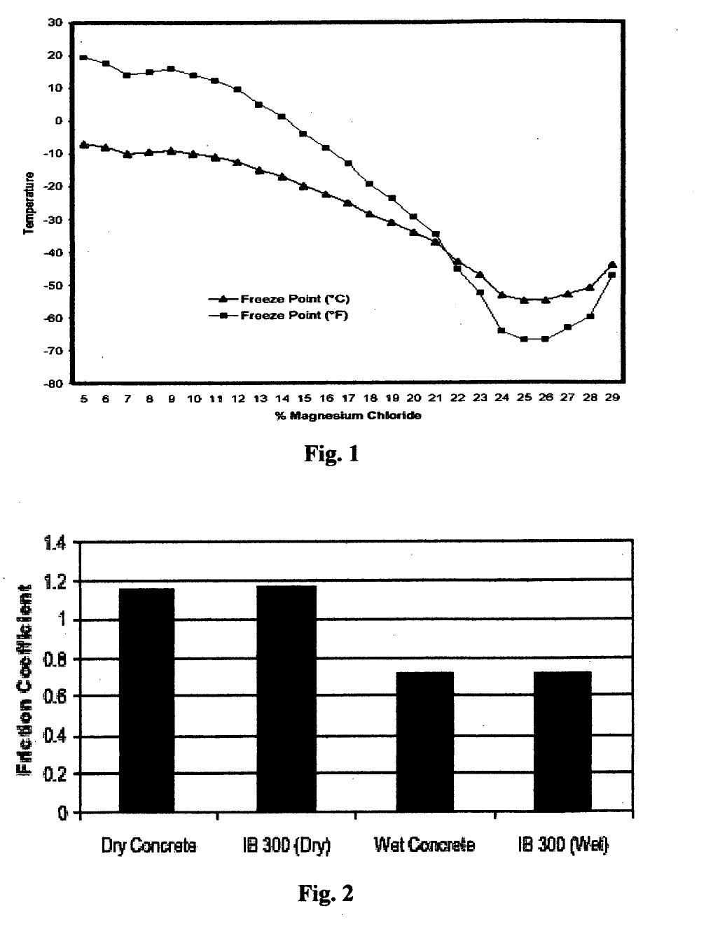

The deicing composition of the present invention is a by-product of a wet biomass process, for example the wet-milling of shelled corn as shown above in FIG. 1. A wet milling process is often employed to obtain staple products such as corn oil, dextrose, corn syrup, high fructose corn syrup, dextrins, dry starches and animal feeds. The principle steps in a wet milling of corn include steeping, milling, recovering and processing. During the steeping process, corn kernels are softened by soaking them in a hot solution containing a very small amount of sulfuric or sulfurous acid. The softened kernels are then separated from the steepwater and further processed depending upon the desired end product. The remaining steepwater contains solubles which, after the steepwater is evaporated and/or dried, are typically recovered for use as nutritional additives in feeds for livestock.

One preferred embodiment includes using a wet milling corn process by-product as the active substance in the composition of the present invention. Accordingly, the composition of this embodiment of the present invention comprises in an amount of between 14 to 80% by weight of steepwater solubles in admixture with between 20 to 86% by weight of water, which composition may be further admixed with optional additives such as slats of magnesium chloride, calcium chloride, sodium chloride, and brine mixtures thereof. It should be noted and well understood, however, that the weight percent of steepwater to salt or brine may be from 1-99% steepwater or 99-1% salt or brine depending on the specifc purpose or use. These compositions are excellently suited to serve as anti-freeze and deicing agents for helping to make and/or keep sidewalks, driveways, roof eaves, patios, porches and other surfaces free of snow and ice. Optimally, the deicing composition of the present invention is applied to surfaces prior to the accumulation of snow and ice, the application of which will help prevent the snow and ice from adhering to prepared surfaces. Subsequent to the accumulation of snow and ice, the deicing composition of the present invention is again applied, but this time to the accumulated snow and ice. The two-step application will facilitate removal of the accumulated snow and ice.

Given that many homeowners, landlords and facility managers typically purchase quantities of chloride salts and other chemical anti-icing agents, it is foreseeable that the composition of the present invention may be mixed or admixed with chloride salts, and possibly calcium magnesium acetate (though the addition of chloride salts, depending on its concentration, may degrade the low corrosiveness and the environmental friendliness of the present invention).

The deicing compositions of the present invention also serve as a corrosion inhibiting agents when mixed with corrosive salts. Tests have shown that the corrosive effect of an admixture of the composition of the steepwater example, together with a five percent by weight of chloride salt is significantly less than for example, an admixture of 95 percent water and five percent salts. Thus, the example composition of the present invention can be effectively mixed with small amounts of salt without significantly affecting the other characteristics of the composition.

According to a further aspect of the present invention the composition may also be applied after snow and ice has accumulated in order to melt said snow and ice.

There are no known or identified hazards to humans, animals or the environment from the handling, storing, or using of a steepwater or other wet biomass concentrate. Steepwater and other wet biomass byproducts are currently used as a low grade animal feed additive or for other low value uses. The condensate of these materials is typically lower in carbohydrate concentration and often clear or translucent in appearance and therefore preferred by some and less by others—depending on the commercial application.

Another potential use for the resulting composition that includes the wet biomass condensate with no biocide is for use in portable toilets for freezing point depression and in conjunction with chloride salts, for use as an antiseptic. The higher chloride concentration compositions will provide excellent oxidative properties and chlorination for human wastes.

A biocide free, clear condensate is one of the preferred embodiments of the present invention.

The main advantages of the composition according to the present invention may be summarized as follows:

1) The composition of the present invention is neither unacceptably corrosive nor environmentally damaging. This is a significant advantage over known compositions which damage vehicles, roadways, and the surrounding environment such as plants, water and air.

2) The composition of the present invention has a freezing point below 0 F. It is liquid and free flowing at +10 F., and can be easily sprayed and applied to road surfaces or accumulated ice or snow at ambient temperatures. The composition can also be heated before its application.

3) The composition can be applied in comparatively small amounts because once applied to the road surface, the composition of the present invention tends to remain in place and is not easily blown away by the wind or by the action of passing traffic, and the composition tends to prevent the adherence of snow and ice to the surfaces upon which it is applied.

4) The composition can be applied during any prevailing temperature and/or prior to impending snow and ice storms.

5) The composition can easily be applied to the outdoor surfaces with uniformity using readily available equipment without any special training.

6) The composition is a low grade, low price industrial by-product available in large quantities in many of the states located in the Snow Belt. Its availability in potential market areas will help keep costs down because the proximity of the solution to the problem areas reduces the transportation costs.

7) The composition is a renewable agricultural by-product and its commercial usage will help support U.S. farmers and the agricultural industry.

8) The composition of the present invention is biodegradable, and yet has a low biological oxygen demand (BOD). The BOD of a substance is a unit-less number that represents the ratio of oxygen utilized (in lbs.) per pound of said substance. The BOD in effect represents the metabolic needs of aerobic microorganisms in organically rich matter. Most known deicers are not biodegradable (and hence have a BOD of 0)—instead, they accumulate and become poisonous to the environment. One known deicer which is biodegradable is calcium magnesium acetate (CMA), but the present invention has a substantially lower BOD than does CMA.

A typical steepwater concentrate composition for the light steepwater condensate is described below. The light grade products are either clear or translucent and are completely characterized as follows:

Ice Ban® 300 is a combination of clear steepwater condensate and one or more salts that together provide for a deicing composition that represents an embodiment of the present invention.

Ice Ban® 300 delivers the proven performance of an organically based corrosion inhibitor with an undetected Biochemical Oxygen Demand (BOD) value helping to significantly reduce eutrophication and algae blooms in sensitive environmental areas such as reservoirs, watersheds and waterways. It is used for installed bridge deck systems, and remains in the liquid state to −67° F. to insure that in times of critical need icing will be eliminated and there will be no appreciable effect on the environment.

Ice Ban 300 is designed as an anti-icing and deicing liquid for sensitive environmental areas where significant reductions in phosphorus and nutrients are necessary to protect a fragile eco-system. Ice Ban 300 is a clear, colorless Magnesium Chloride based liquid delivering excellent performance, extremely low corrosion rates. As an anti-icer and deicer, Ice Ban® 300 provides a clear, non-staining, non-tracking formula with a very mild odor.

All of these attributes provide a product designed to maintain high service levels for the roads and the environment.

The included tables illustrate the engineered chemical and physical characteristics of Ice Ban 300.

TABLE 1
Chemical Analysis for Ice Ban ® 300
with a 25% solids concentration of MgCl₂

| Component | Units | Typical | PNS Limit |
|---|---|---|---|
| MgCl2 | % | 25 | 25 |
| Phosphorus | Ppm | 0.08 | 25 |
| Cyanide | Ppm | <0.05 | 0.2 |
| Arsenic (As) | Ppm | <1.0 | 5 |
| Copper (Cu) | Ppm | <0.1 | 0.2 |
| Lead (Pb) | Ppm | <0.50 | 1 |
| Mercury (Hg) | Ppm | <0.02 | 0.05 |
| Chromium (Cr) | Ppm | <0.08 | 0.5 |
| Cadmium (Cd) | Ppm | <0.05 | 0.2 |
| Barium (Ba) | Ppm | <0.50 | 10 |
| Selenium(Se) | Ppm | <0.20 | 5 |
| Zinc (Zn) | Ppm | 0.26 | 10 |
| Molybdenum(Mo) | Ppm | 5.8 | — |
| Ammonia | Ppm | 4.4 | — |
| pH (1:4 Solution) | | 8.2 | 6-10 |
| Corrosion Rate | % | 24.9 | <30 |

TABLE 2
Typical Physical Properties for Ice Ban ® 300

| Component | Units | Typical |
|---|---|---|
| Specific Gravity | SGU (at 20° C.) | 1.250 |
| TTL Settleable Solids (V/V) | % | <=1 |
| Solids Passing # 10 Sieve (V/V) | % | >=99 |
| Freeze Point | | −55° C./−67° F. |

The phase curve diagram FIG. 1 illustrates the increased effective range that Ice Ban 300 offers over 30% Magnesium Chloride, 30% Calcium Chloride and 26% Sodium Chloride (Salt). Ice Ban 300 has a eutectic point of −77° F. at a 21% Magnesium Chloride concentration solution. The increased working range of 300 greatly reduces the likelihood that the melted snow and ice will re-freeze between applications, reducing the need for excess treatments and additional trips by workers.

Testing performed by Forensic Dynamics, Inc. in July 2001 FIG. 2 on the friction characteristics of Ice Ban® 300 shows that a concrete surface treated with 300 had a friction coefficient slightly less than that of concrete wetted with water. When dry, the Ice Ban treated surface has a friction coefficient higher than that of dry concrete. In fact, Ice Ban 300 was one of the best performers using Magnesium Chloride, in terms of friction coefficient based products ever tested.

TABLE 3
Specific Gravity Chart for Ice Ban 300

| % MgCl2 | Freeze Point (° C.) | Freeze Point (° F.) | Specific Gravity |
|---|---|---|---|
| 5 | −7.0 | 19.4 | 1.051 |
| 6 | −8.0 | 17.6 | 1.061 |
| 7 | −10.0 | 14.0 | 1.072 |
| 8 | −9.5 | 14.9 | 1.082 |
| 9 | −9.0 | 15.8 | 1.092 |
| 10 | −10.0 | 14.0 | 1.101 |
| 11 | −11.0 | −12.2 | 1.111 |
| 12 | −12.5 | 9.5 | 1.119 |
| 13 | −15.0 | 5.0 | 1.130 |
| 14 | −17.0 | 1.4 | 1.138 |
| 15 | −20.0 | −4.0 | 1.148 |
| 16 | −22.5 | −8.5 | 1.158 |
| 17 | −25.0 | −13.0 | 1.167 |
| 18 | −28.5 | −19.3 | 1.178 |
| 19 | −31.0 | −23.8 | 1.184 |
| 20 | −34.0 | −29.2 | 1.192 |
| 21 | −37.0 | −34.6 | 1.199 |
| 22 | −43.0 | −45.4 | 1.213 |
| 23 | −47.0 | −52.6 | 1.219 |
| 24 | −53.5 | −64.3 | 1.231 |
| 25 | −55.0 | −67.0 | 1.238 |
| 26 | −55.0 | −67.0 | 1.245 |
| 27 | −53.0 | −63.4 | 1.255 |
| 28 | −51.0 | −59.8 | 1.262 |
| 29 | −44.0 | −47.2 | 1.276 |

Ice Ban ® 300 is intended for use as an ice and snow removal liquid chemical on highways and roads.

The storage of Ice Ban® 300 requires the normal precautionary procedures used for the safe handling of liquids. Periodic re-circulation is suggested during long term storage. The use of the caustic prewash and resulting residual should minimize or completely eliminate undesirable microbial growth.

Ice Ban® 300 was tested in accordance with National Association of Corrosion Engineers (NACE) Standard TM-01-69 (1976 rev.), PNS (Pacific Northwest Snow Standards) modified exhibits corrosion values of at least 75% less than that of Sodium Chloride. Ice Ban® 300 does not contribute to concrete scaling problems and has no adverse effect on the cohesive or adhesive strength of asphalt films.

Typically, Ice Ban® 300 is used as a stockpile treatment agent or pre-wetting agent at the rate of 8 gallons per ton of salt and 10-12 gallons per ton of abrasives.

TABLE 4
Chemical Analysis of Clear Condensate - Ice Ban ® 300

| Component | Units | Typical | PNS Limit |
|---|---|---|---|
| MgCl2 | % | 25 | 25 |
| Phosphorus | Ppm | 0.08 | 25 |
| Cyanide | Ppm | <0.05 | 0.2 |
| Arsenic (As) | Ppm | <1.0 | 5 |
| Copper (Cu) | Ppm | <0.1 | 0.2 |
| Lead (Pb) | Ppm | <0.50 | 1 |
| Mercury (Hg) | Ppm | <0.02 | 0.05 |
| Chromium (Cr) | Ppm | <0.08 | 0.5 |
| Cadmium (Cd) | Ppm | <0.05 | 0.2 |
| Barium (Ba) | Ppm | <0.50 | 10 |
| Selenium(Se) | Ppm | <0.20 | 5 |
| Zinc (Zn) | Ppm | 0.26 | 10 |
| Molybdenum(Mo) | Ppm | 5.8 | — |
| Ammonia | Ppm | 4.4 | — |
| pH (1:4 Solution) | | 8.2 | 6-10 |
| Corrosion Rate | % | 24.9 | <30 |

TABLE 4
Physical Properties of Clear Condensate Ice Ban ® 300

| Component | Units | Typical |
|---|---|---|
| Specific Gravity | SGU (at 20° C.) | 1.250 |
| TTL Settleable Solids (V/V) | % | <=1 |
| Solids Passing # 10 Sieve (V/V) | % | >=99 |
| Freeze Point | | −55° C./−67° F. |

The properties of Ice Ban® 300 described above do not include the residual from caustic washing as described in the present invention and therefore represent samples prior to containment in a caustically washed vessel.

Other embodiments include; any condensate from any biomass byproduct that is “wet” processed such as barley, wheat, beets, sugar cane, sorghum, soy, kudzu, brewers condensed solubles (yeast), whey, etc., allowing for a readily available process stream that has otherwise low feed or other value and that with caustic washing and raising of the pH of the condensate requires no use of biocide to prevent or eliminate microbial growth. Low carbohydrate concentration process streams which would otherwise be discarded are prime targets of the present invention and are to be considered as an additional basis of the present invention. While higher carbohydrate concentration process streams would also qualify as candidates for the present invention, it is understood that feed value may overwhelm the value of their use as antifreeze or deicing agents.

The use of caustic for cleaning railcars and truck tank cars is well known by those in industry. Caustic is defined as a strong base (alkaline) substance which irritates the skin. It is corrosive in nature and when the term caustic is used alone, it usually refers to caustic soda (sodium hydroxide) which is used in manufacturing hard soap. It also refers to caustic potash (potassium hydroxide) which is used in manufacturing soft soap. Caustic soda is used in a wide variety of industrial applications. It is used as a reactant in the manufacture of other sodium compounds which themselves may be intermediate or end-use products, such as sodium hypochlorite which is used as a household bleach and disinfectant and sodium phenolate which is used in antiseptics and for the manufacture of aspirin. It is used in the manufacturing process of soaps and surfactants for used in soap powders and also in the textile industry to remove contaminants, as a bleach in the treatment of scoured cloth and to improve luster and dye absorption.

Caustic soda has a variety of uses in the Food Industry, some examples are:

Refining of animal and vegetable oils to remove fatty acids prior to use in foodstuff production

Dry formulations for bottle washing etc.

General cleansing operations

Cleaning of brewery equipment

Lye peeling of potatoes, fruit and vegetables

Caustic soda is used extensively in the water industry for pH control and ion exchange resin regeneration. Other uses include effluent neutralization and descaling of pipe work systems.

Much tank car cleaning is conducted at shipping and receiving terminals, where the wastes go to the manufacturers' treatment systems. However, 30 to 40 percent is done at service stations operated by tank car owners/lessors. These installations clean waste of a wide variety of commodities, many of which require special cleaning methods.

A typical tank car cleaning facility cleans 4 to 10 cars per day. Car capacity varies from 40 to 130 cubic meters (10,000 to 34,000 gallons). Cleaning agents include steam, water, detergents, and solvents, which are applied using steam hoses, pressure wands, or rotating spray heads placed through the opening in the top of the car. Scraping of hardened or crystallized products is often necessary. Cars carrying gases and volatile materials, and those needing to be pressure tested, must be filled or flushed with water. The average amount of residual material cleaned from each car is estimated to be 250 kilograms (kg) (550 pounds). Vapors from car cleaning not flared or dissolved in water are dissipated to the atmosphere.

Two-thirds of the tank trucks in service in the United States are operated for hire. Of these, 80 percent are used to haul bulk liquids. Most companies operate fleets of 5 trucks or less, and whenever possible, these trucks are assigned to dedicated service.

Commodities hauled and cleaned are 15 percent petroleum products, 35 percent organic chemicals, 5 percent food products, and 10 percent other products.

Interior washing is carried out at many tank truck dispatch terminals. Cleaning agents include water, steam, detergents, bases, acids, and solvents, which are applied with hand-held pressure wands or by Turco or Butterworth rotating spray nozzles. Detergent, acidic, or basic solutions are usually used until spent and then sent to treatment facilities.

Solvents are recycled in a closed system, with sludges either incinerated or landfilled. The average amount of material cleaned from each trailer is 100 kg (220 lb). Vapors from volatile material are flared at a few terminals, but most commonly are dissipated to the atmosphere. Approximately 0.23 m³ (60 gal) of liquid are used per tank truck steam cleaning and 20.9 m³ (5500 gal) for full flushing.

The following procedures should be carefully followed in preparing the empty tank car for return as prescribed by Dow Chemical company (one manufacturer of caustic);
1. Disconnect the steam lines, if used, and blow out the heating coils with compressed air.
2. After removing all connections, replace the closures on all tank car openings.
3. While inside a containment area, wash the unloading lines or hoses and any minor spills on or around the tank car with water. NOTE: Typically, compressed air is used for pressurized unloading operations. However, if nitrogen or another inert gas is used for unloading caustic soda (for safety or other reasons) instead of air, the gas should be properly vented before the tank car is returned. In any event, the tank car should be returned under atmospheric pressure with air. Fasten dome cover securely.

Strong alkali solutions normally include; sodium hydroxide, sodium orthosilicate, sodium sesquisilicate, and the like and are often used as detergents to remove fat and protein with highly corrosive properties. Mild alkali solutions normally include; sodium carbonate, sodium sesquisilicate, trisodium phosphate, sodium tetraborate, and the like and are often used as buffers at pH 8.4 or above as well as providing water softeners with mildly corrosive properties. High concentrations are irritating to skin

In many areas, the use of such caustic solutions is controlled by law or industry requirements. The caustic solutions used in such operations can attack the surfaces of glass and metal causing scratching and loss of material. Such washing systems are often highly automated and employ a high temperature caustic solution to wash the surfaces. The caustic solutions employed for washing operations typically comprise 1% to 10% (all percentages stated herein are in weight percent) of caustic, typically, sodium hydroxide. The wash solution may also include antifoaming agents and/or metal corrosion inhibiting additives.

It is emphasized again that the present invention is directed to the discovery that use of the caustic washing leaves a residue in either the tank car or truck tanker or other appropriate holding facility such that when steepwater or other biomass condensates are added to the tanker car, the pH of the condensates reach at least a pH of 8 and more often at least a pH of 8.5, thereby negating any requirement for a biocide or other anti-microbial or anti-biofouling agent(s), as this basic medium has been found to retard or eliminate microorganism growth.

Additionally, this “automatic” adjustment of the pH to any wet biomass byproduct condensate composition that also has the effect of microbial growth inhibition or microbial growth prevention is also included as another aspect of the present invention.

What is claimed is:

1. A method of treating soluble organic compounds combined with any concentration of salt or brine and capable of aerobic and anaerobic microorganism growth comprising:
applying sufficient caustic in a caustic wash to an inside surface of any liquid media transport device, such that said caustic or caustic residue associated with said caustic wash results in mitigating or eliminating said microorganism growth.

2. A method according to claim 1, wherein said caustic in said caustic wash is in a concentration of at least 1% by weight of said soluble organic compound and wherein said caustic and said caustic residue is comprised of primarily either sodium or potassium hydroxide.

3. A method according to claim 1, wherein said soluble organic compound is a byproduct of any wet processed biomass, and wherein said byproduct is primarily a condensate.

4. A method according to claim 3, wherein said byproduct is sufficiently low in carbohydrate concentration to be considered of low or no feed value.

5. A method according to claim 3, wherein said byproduct is a condensate of said biomass.

6. A method according to claim 3, wherein said condensate is steepwater.

7. A method according to claim 3, wherein said steepwater is derived from wet milling grains such as corn, soybean, wheat, barley or sorghum.

8. A method according to claim 3, wherein said steepwater is biocide free, clear or translucent steepwater condensate, and wherein said steepwater is combined in any ratio on a volume or weight percentage basis with salts such as MgCl, CaCl₂, NaCl or a brine and the like.

9. A method according to claim 1, wherein said caustic wash comprises highly alkaline detergents including caustic soda (sodium hydroxide) or caustic potash (potassium hydroxide) or moderately alkaline detergents including sodium, potassium, or ammonium salts of phosphates, silicates, or carbonates, including tri-sodium phosphate, wherein said silicates are corrosion inhibitors and wherein said carbonates may be of limited use due to interaction with calcium and magnesium causing film formation that may or may not be useful.

10. A method according to claim 9, wherein said caustic soda or caustic potash in said caustic wash is present in a concentration of no less than 1% by weight and preferably 10% by weight or greater.

11. A method according to claim 9, wherein caustic wash comprises sodium, potassium, or ammonium salts of phosphates, silicates, or carbonates, including tri-sodium phosphate present in a concentration of no less than 1% by weight and preferably 10% by weight or greater.

12. A method according to claim 1, wherein said caustic wash may be wiped, rolled or sprayed onto an inside surface of a holding vessel of a transport device for said soluble organic compounds combined with any concentration of salt or brine.

13. A method according to claim 1, wherein said caustic or caustic residue stabilizes the pH of said soluble organic compounds combined with any concentration of salt or brine to at least 8.0 or greater.

14. A method according to claim 1, wherein said transport device is a rail tank car, truck tank trailer or other liquid transport device.

15. A composition combination for deicing or freezing point depression utilizing any suitable soluble organic compound combined with any concentration of salt or brine together with a caustic or caustic wash residue comprising highly alkaline detergents including caustic soda (sodium hydroxide) or caustic potash (potassium hydroxide) or moderately alkaline detergents including sodium, potassium, or ammonium salts of phosphates, silicates, or carbonates, including tri-sodium phosphate, wherein said silicates are corrosion inhibitors and wherein said carbonates may be of limited use due to interaction with calcium and magnesium causing film formation that may or may not be useful in mitigating or elimination microorganism growth.

16. The composition combination of claim 15, wherein said composition provides sufficient caustic or said caustic wash residue that results in mitigating or eliminating microorganism growth and wherein the resulting composition is its useful in treating inside surfaces of any liquid media transport device thereby mitigating or eliminating microorganism growth.

17. A composition according to claim 16, wherein said caustic soda or caustic potash in said caustic wash residue in combination with said composition is present in a concentration of no less than 1% by weight and preferably 10% by weight or greater.

18. A composition according to claim 16, wherein said caustic wash residue in combination with said composition comprises sodium, potassium, or ammonium salts of phosphates, silicates, or carbonates, including tri-sodium phosphate present in a concentration of no less than 1% by weight and preferably 10% by weight or greater.

19. A composition according to claim 15, wherein said caustic or said caustic wash residue in combination with said composition may be wiped, rolled or sprayed onto an inside surface of a holding vessel of a transport device for said soluble organic compounds.

20. A composition according to claim 15, wherein said caustic or caustic wash residue in combination with said composition stabilizes the pH of said composition to at least 8.0 or greater.

21. A composition according to claim 15, wherein said transport device is a rail tank car, truck tank trailer or other liquid transport device.

22. A composition according to claim 15, wherein said soluble organic compound is a byproduct of a wet processed biomass.

23. A composition according to claim 22, wherein said byproduct is sufficiently low in carbohydrate concentration to be considered of low or no feed value.

24. A composition according to claim 23, wherein said byproduct is a condensate of said biomass.

25. A composition according to claim 24, wherein said condensate is steepwater and wherein said steepwater is combined in any ratio on a volume or weight percentage basis with salts such as MgCl, CaCl₂, NaCl, or a brine and the like.

26. A composition according to claim 25, wherein said steepwater is derived from wet milling grains such as corn, soybean, wheat, barley or sorghum.

27. A composition according to claim 26, wherein said steepwater is biocide free, clear or translucent steepwater condensate.

28. A system for deicing or freezing point depression utilizing any suitable soluble organic compound combined with any concentration of salt or brine together with a caustic or caustic wash residue comprising highly alkaline detergents including caustic soda (sodium hydroxide) or caustic potash (potassium hydroxide) or moderately alkaline detergents including sodium, potassium, or ammonium salts of phosphates, silicates, or carbonates, including tri-sodium phosphate, wherein said silicates are corrosion inhibitors and wherein said carbonates may be of limited use due to interaction with calcium and magnesium causing film formation that may or may not be useful in mitigating or elimination microorganism growth.

29. The system of claim 28, wherein said composition provides sufficient caustic associated with said caustic wash residue that results in mitigating or eliminating microorganism growth and wherein the resulting composition is its useful in treating inside surfaces of any liquid media transport device thereby mitigating or eliminating microorganism growth.

30. A system according to claim 28, wherein said caustic soda or caustic potash in said caustic wash residue in combination with said composition is present in a concentration of no less than 1% by weight and preferably 10% by weight or greater.

31. A system according to claim 29, wherein said caustic or caustic wash residue in combination with said composition comprises sodium, potassium, or ammonium salts of phosphates, silicates, or carbonates, including tri-sodium phosphate present in a concentration of no less than 1% by weight and preferably 10% by weight or greater.

32. A system according to claim 30, wherein said caustic or caustic wash residue in combination with said composition may be wiped, rolled or sprayed onto an inside surface of a holding vessel of a transport device for said soluble organic compounds combined with any concentration of salt or brine.

33. A system according to claim 31, wherein said caustic or caustic wash residue in combination with said composition stabilizes the pH of said composition to at least 8.0 or greater.

34. A system according to claim 32, wherein said transport device is a rail tank car, truck tank trailer or other liquid transport device.

35. A system according to claim 28, wherein said soluble organic compound is a byproduct of a wet processed biomass.

36. A system according to claim 34, wherein said byproduct is sufficiently low in carbohydrate concentration to be considered of low or no feed value.

37. A system according to claim 35,wherein said byproduct is a condensate of said biomass.

38. A system according to claim 36, wherein said condensate is steepwater and wherein said steepwater is combined in any ratio on a volume or weight percentage basis with salts such as MgCl, CaCl₂, NaCl, or a brine and the like.

39. A system according to claim 37, wherein said steepwater is derived from wet milling grains such as corn, soybean, wheat, barley or sorghum.

40. A system according to claim 37, wherein said steepwater is biocide free, clear or translucent steepwater condensate.
